(19) United States
(12) Patent Application Publication
(10) Pub. No.: US 2010/0077883 A1
(43) Pub. Date: Apr. 1, 2010

(54) Impact Reducing Device for Shift Lever

(75) Inventor: Jaesung Heo, Seoul (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/537,911

(22) Filed: Aug. 7, 2009

(30) Foreign Application Priority Data
Sep. 29, 2008 (KR) 10-2008-0095329

(51) Int. Cl. B60K 20/02

(52) U.S. Cl. 74/473.36

(57) ABSTRACT

An impact reducing device for a shift lever is provided that enables more safely protecting a driver while effectively reducing impact applied to the driver by a shift lever, by moving the entire shift lever assembly downward while breaking a portion of a bushing by which the shift lever is mounted in a base bracket when impact is applied to the shift lever, a hinge shaft of the shift lever assembly is rotatably fitted and supported in the bushing, which is detachably mounted in the base bracket.

### CROSS-REFERENCE TO RELATED APPLICATION

The present application claims priority to Korean Patent Application Number 10-2008-0095329 filed Sep. 29, 2008, the entire contents of which application is incorporated by reference herein for all purposes by this reference.

### BACKGROUND OF THE INVENTION

1. Field of the Invention

The present invention relates to a shift lever of a vehicle, particularly an impact reducing device for a shift lever that is separated downward from a base bracket to protect a passenger, when impact is applied to the shift lever.

2. Description of Related Art

In vehicles in the related art, a head impact region is set to prevent the driver's head from being injured in a front collision and a critical impulse is set by performing a head impact experiment for parts at the corresponding portion in the vehicle and managed to prevent the driver from being injured, when the driver is dumped against the parts.

The outfit-parts are designed to be broken before impulse reaches the critical impulse in order to satisfy the critical impulse; however, it is difficult to design the shift lever of an automatic transmission to be easily broken by impact, because a driver frequently operates the shift lever while applying force larger than a predetermined level.

According to an anti-impact structure of a shift lever mounted in the FACIA in the related art, the entire shift lever moves down to reduce the impact that is applied to the driver by the shift lever when impact is applied to the shift lever, by forming a slot hole where the shift lever is mounted; however, this is difficult to be implemented due to a limit on the design of the shift lever mounting bracket.

Further, a method of reducing impact by forming a shock-absorbing space inside an operation knob of a shift lever such that the operation knob is deformed inside the shock-absorbing space when impact is applied to the shift lever has been proposed but this is difficult to be implemented due to a limit on the design of the operation knob.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide an impact reducing device for a shift lever that enables more safely protecting a driver while effectively reducing impact applied to the driver by a shift lever, by moving the entire shift lever assembly downward while breaking a portion of a bushing by which the shift lever is mounted in a base bracket when impact is applied to the shift lever.

In an aspect of the present invention, an impact reducing device for a shift lever is provided, wherein a hinge shaft of a shift lever assembly receiving the shift lever is rotatably fitted and supported in a bushing detachably mounted in a base bracket

The bushing may have a bushing body into which the hinge shaft is rotatably fitted and at least a locking protrusion that integrally protrude from at least a side of the bushing body, are locked in fitting holes formed in the base bracket, the at least a locking protrusion being configured to be broken when impact larger than a predetermined level is applied to the shift lever.

The bushing may be fitted on a mounting hole formed in the base bracket, and at least a support protrusion, which protrude outwards from the base bracket to support the bushing and are broken when impact larger than a predetermined level is applied, are formed around the mounting hole.

The at least a support protrusion may include a locking step at the end thereof and configured to be locked into the fitting holes.

The hinge shaft of the shift lever assembly may be coupled to an assembly hole of the bushing through the mounting hole.

The at least a support protrusion may include a first support protrusion and a second support protrusion, which support distal lower end portions of the bushing respectively.

The mounting hole may be shaped open downwards.

In another aspect of the present invention, since the lower hinge shaft of the shift lever assembly is fitted in the bushing detachably mounted in the base bracket by the locking protrusions, the locking protrusions of the bushing and the support protrusions of the base bracket reduce impact by absorbing first the impact while being broken, when impact larger than a predetermined level is applied to the shift lever. Further, as the locking protrusions and the support protrusions are broken, the shift lever assembly and the bushing are moved downward from the base bracket, such that it is possible to minimally reduce repulsion impact that is transmitted to a driver by the shift lever and effectively prevent the driver from being injured by the impact.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of an exemplary base bracket according to the present invention.

FIG. 2 shows a perspective view and a plan view of an exemplary bushing according to the present invention.

FIG. 3 is a perspective view showing when an exemplary shift lever assembly is combined with the base bracket by the bushing according to the present invention.

FIG. 4 is a view illustrating the operation of an exemplary impact reducing device according to the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

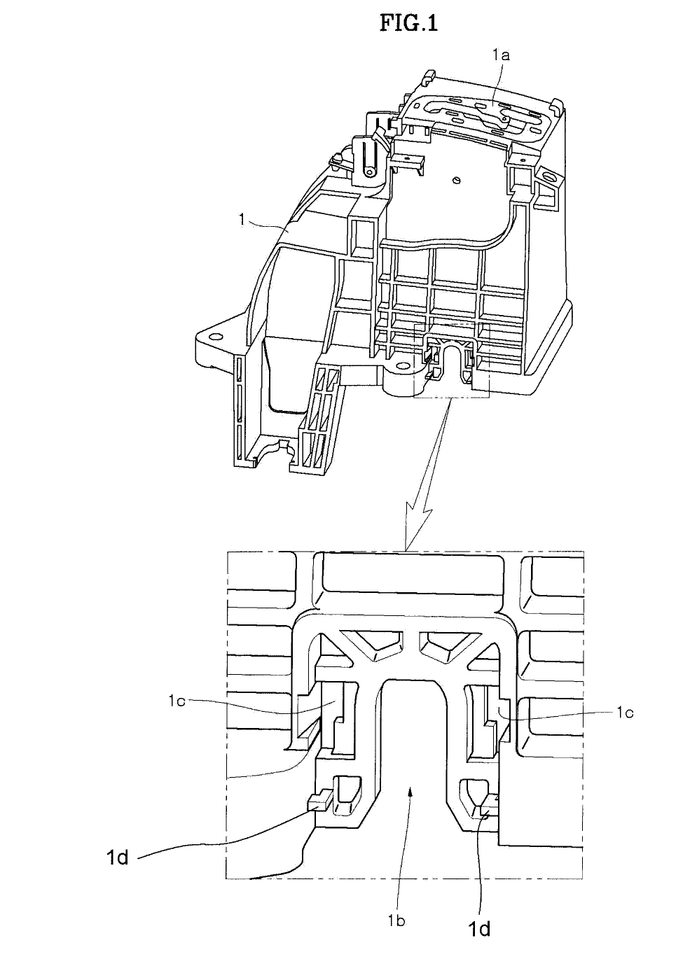

FIG. 1 is a perspective view of a base bracket according to various embodiments of the present invention, in which a base bracket 1 is formed substantially a rectangular box shape, which has a shift lever guide hole 1a at the upper portion to guide a shift lever, and a mounting hole 1b for mounting a bushing and fitting holes 1c for fitting locking protrusions of the bushing at a side of the lower portion which is open, as explained hereinafter.

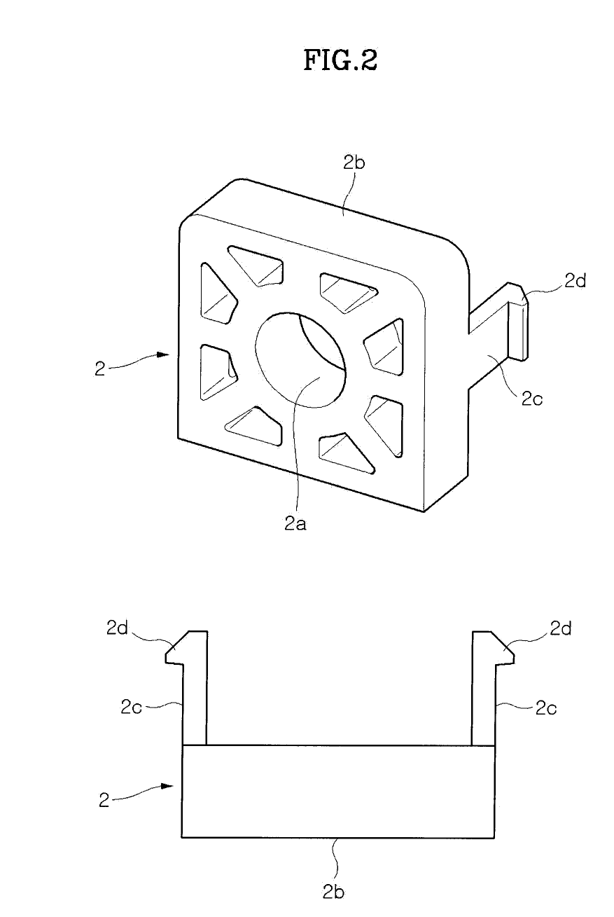

FIG. 2 shows the structure of a bushing according to various embodiments of the present invention, in which a bushing 2 may be formed in a rectangular shape, and locking protrusions 2c integrally protrude from both sides of a bushing body 2b with an assembly hole 2a at the center and a bent locking step 2d is formed at the end of locking protrusion 2c.

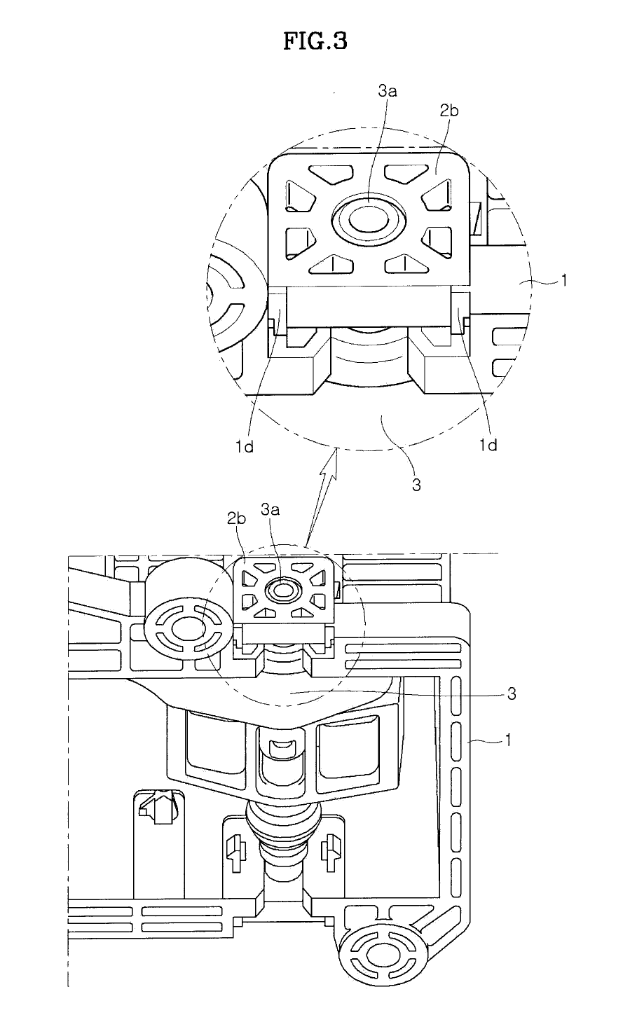

FIG. 3 is a perspective view showing when a shift lever assembly is combined with the base bracket by the bushing having the above structure, in which a lower hinge shaft 3a of a shift lever assembly 3 is rotatably fitted and supported in assembly hole 2a of bushing 2 and bushing 2 is fitted in mounting hole 1b formed at the lower side of base bracket 1 such that locking protrusions 2c are inserted in fitting holes 1c and locked to the locking steps 2d.

Further, two support protrusions 1d, where both lower edges of bushing body 2b are placed onto and supported, protrude outwards from a lower portion of the base bracket 1 to support the bushing 2 mounted on mounting hole 1b.

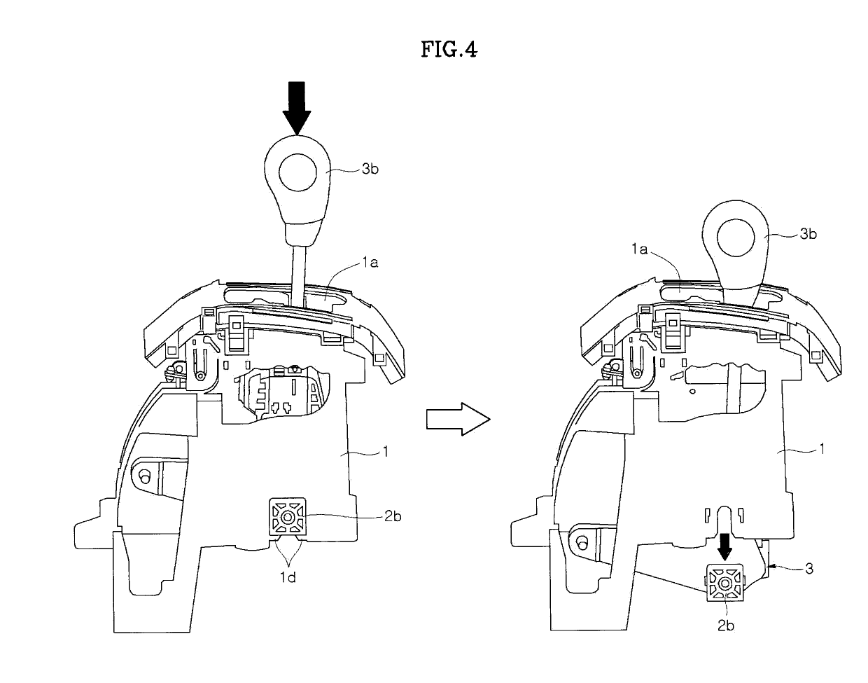

FIG. 4 shows that the shift lever assembled as described above is separated downward when impact is applied.

With a shift lever 3b protruding outside through shift lever guide hole 1a of base bracket 1, when impulse larger than a predetermined level is applied to the shift lever by the driver's body, such as the head, dumped against the shift lever in a front collision of a vehicle, the impact applied to the shift lever is transmitted to support protrusions 1d of the base bracket and locking protrusions 2c of the bushing 2, such that they reduce first the impact by absorbing the impact while being broken. Further, as the locking protrusions and the support protrusions are broken, the bushing is released from the base bracket 1 and the shift lever assembly combined together with the bushing 2 is moved downward from the base bracket 1 since the mounting hole 1b is shaped open downwards, such that repulsion impact that is applied to the driver from the shift lever is effectively reduced, thereby preventing the driver from being injured by the shift lever.

For convenience in explanation and accurate definition in the appended claims, the terms “upper” and “lower” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An impact reducing device for a shift lever, wherein a hinge shaft of a shift lever assembly receiving the shift lever is rotatably fitted and supported in a bushing detachably mounted in a base bracket.

2. The impact reducing device for the shift lever as defined in claim 1, wherein the bushing has a bushing body into which the hinge shaft is rotatably fitted and at least a locking protrusion that integrally protrude from at least a side of the bushing body, are locked in fitting holes formed in the base bracket, the at least a locking protrusion being configured to be broken when impact larger than a predetermined level is applied to the shift lever.

3. The impact reducing device for the shift lever as defined in claim 2, wherein the bushing is fitted on a mounting hole formed in the base bracket, and at least a support protrusion, which protrude outwards from the base bracket to support the bushing and are broken when impact larger than a predetermined level is applied, are formed around the mounting hole.

4. The impact reducing device for the shift lever as defined in claim 3, wherein the at least a support protrusion include a locking step at the end thereof and configured to be locked into the fitting holes.

5. The impact reducing device for the shift lever as defined in claim 3, wherein the hinge shaft of the shift lever assembly is coupled to an assembly hole of the bushing through the mounting hole.

6. The impact reducing device for the shift lever as defined in claim 3, wherein the at least a support protrusion include a first support protrusion and a second support protrusion, which support distal lower end portions of the bushing respectively.

7. The impact reducing device for the shift lever as defined in claim 3, wherein the mounting hole is shaped open downwards.
